(19) United States
(12) Patent Application Publication
(10) Pub. No.: US 2012/0017543 A1
(43) Pub. Date: Jan. 26, 2012

(54) AGRICULTURAL STORAGE BAG LOADING SYSTEM

(76) Inventor: Edward H. PRIEPKE, Lancaster, PA (US)

(21) Appl. No.: 12/840,357

(22) Filed: Jul. 21, 2010

(51) Int. Cl. B65B 1/04; B65B 43/26; B60P 1/00; B60P 1/04; A01F 25/00; A01F 25/14

(52) U.S. Cl. 53/473; 414/482; 414/813; 53/570

(57) ABSTRACT

A system for loading a bale in a continuous storage bag includes a structure configured and disposed to releasably dispense the bag in response to receiving a bale directed inside the structure, the directed bale being inserted inside the bag. A bale wagon receives the bale and a push-off member directs the bale inside the structure from the bale wagon. A first member is selectably movable between a first position and a second position with respect to the bale wagon to selectably secure the bale wagon to the structure.

### FIELD OF THE INVENTION

The present invention relates generally to agricultural machinery for use with crop harvesting devices. It relates more particularly to a system for unloading bales from a bale wagon into a storage bag.

### BACKGROUND OF THE INVENTION

It is common practice to utilize a bale wagon to move bales to a desired location and then subsequently deposit the formed stack of bales upon the ground, in a covered structure, or individually or collectively directing the bales into a storage bag. In order to safely deposit the stack of bales upon the ground and then bag them if desired, especially large rectangular bales typically weighing hundreds of pounds, mechanical assistance is needed. Bale handling is further complicated when the bales are to be used for silage, typically adding weight and having a higher coefficient of friction associated with pushing the bales off of the bale wagon. A continuous storage bag may be mounted to a framed structure to receive bales unloaded from the bale wagon. There are difficulties associated with aligning a bale wagon with the bag-containing framed structure and securing the bale wagon to the structure prior to bagging the bales. In addition, an adverse change in weight distribution of the bales on the bale wagon may interfere with the unloading operation.

What is needed is a bale unloading system for unloading bales from a bale wagon and into a continuous bag without the above-mentioned disadvantages.

### SUMMARY OF THE INVENTION

A system for loading a bale in a continuous storage bag includes a structure configured and disposed to releasably dispense the bag in response to receiving a bale directed inside the structure, the directed bale being inserted inside the bag. A bale wagon receives the bale and a push-off member directs the bale inside the structure from the bale wagon. A first member is selectably movable between a first position and a second position with respect to the bale wagon to selectably secure the bale wagon to the structure.

A system for loading a bale in a continuous storage bag includes a structure configured and disposed to releasably dispense the bag in response to receiving a bale directed inside the structure, the directed bale being inserted inside the bag. A bale wagon includes a mobile trailer frame having a bed frame for receiving and unloading bales, the bed frame pivotably movable between a first position for receiving bales and a second position for unloading bales. A push-off member directs the bales inside the structure from the bale wagon when the bed frame is in the second position. A first member is selectably pivotable between a first position and a second position with respect to the bale wagon to selectably secure the bale wagon to the structure.

A method for loading a bale in a continuous storage bag includes the steps of providing a structure configured and disposed to releasably dispense the bag in response to receiving a bale directed inside the structure, the directed bale being inserted inside the bag. The method further includes providing a bale wagon configured to receive and to unload the bale and moving a first member with respect to the bale wagon from a first position to a second position. The method further includes guiding the bale wagon toward an engagement position with the structure using the first member in the second position as an alignment guide and securing the first member to the structure, and directing the bale inside the structure.

An advantage of the present invention is a system having the capability of unloading bales having increased weight from the wagon and into a continuous bag without the disadvantages associated with known systems.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a top view of an embodiment of a bale wagon in an unloading position.

FIG. 2 is a cross section taken along line 2-2 of FIG. 1.

FIG. 3 is a side view of bales partially unloaded from the bale wagon of FIG. 2.

FIG. 4 is an enlarged, partial cross section of a push-off member taken along line 2-2 of FIG. 1.

FIG. 5 is a side view of an embodiment of a push-off member.

FIG. 6 is a top view of an alternate embodiment of a bale wagon secured to a bag dispensing structure.

FIG. 7 is an enlarged, partial view of a selectably movable member taken from a region 7 of FIG. 6 with respect to the bale wagon.

FIG. 8 is a side view of FIG. 6.

FIG. 9 is an enlarged, partial view of components taken from a region 9 of FIG. 8 to secure the bag dispensing structure to the bale wagon.

FIG. 10 is a side view of a bale being directed through a bag dispensing structure until the bale is directed past a dispensing member of the structure, becoming a previously directed bale.

FIG. 11 is a side view of a bale being directed through a bag dispensing structure until the bale is directed into abutting contact with the previously directed bale.

FIG. 12 is a plan view of a system for aligning a bale wagon with a bag dispensing structure.

FIG. 13 is schematic representation of portion of a fluid circuit of the bale wagon.

Wherever possible, the same reference numbers will be used throughout the drawings to refer to the same or like parts.

### DETAILED DESCRIPTION OF THE INVENTION

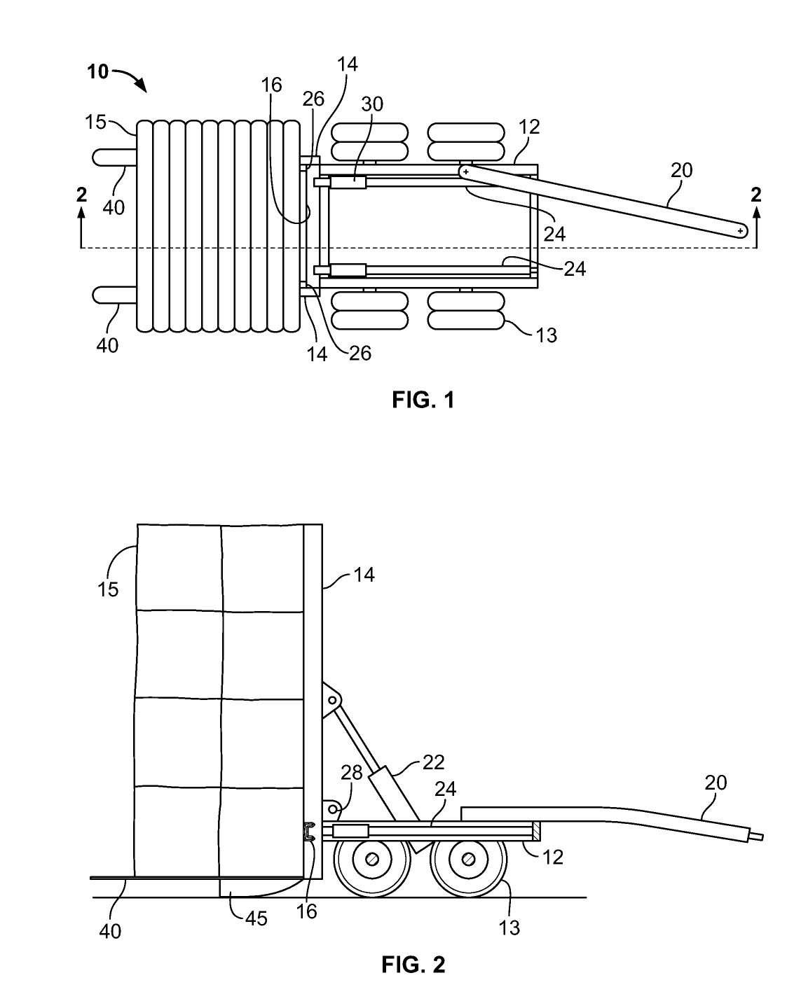

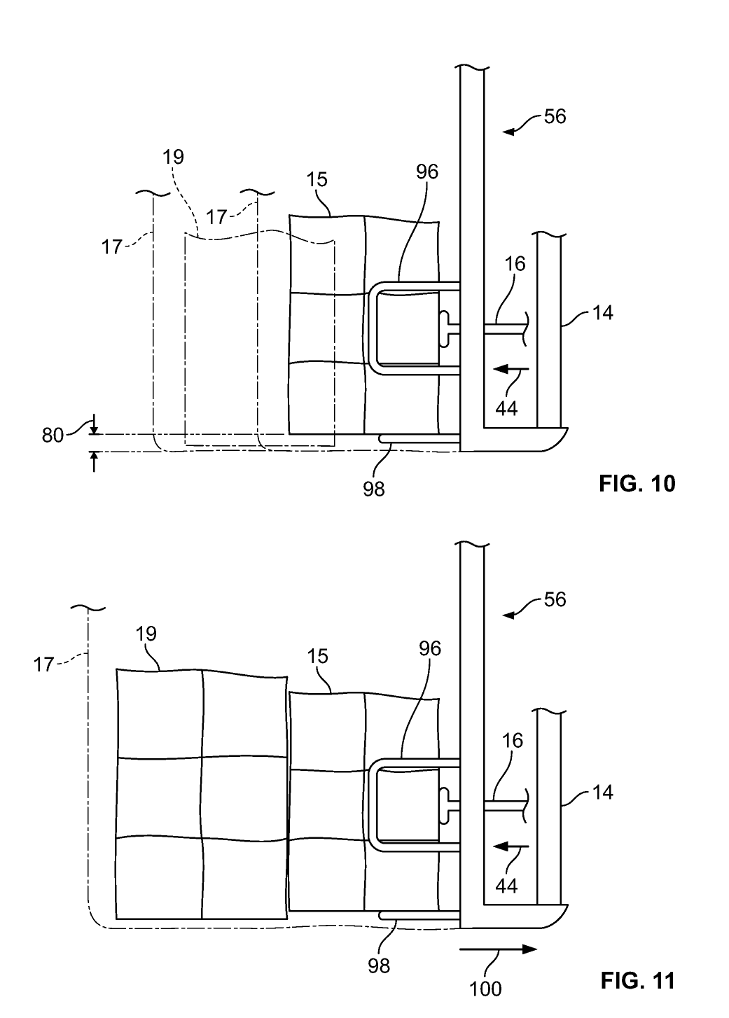

Referring to FIGS. 1-3, a bale wagon 10 includes a mobile trailer frame 12 supported by a plurality of wheels 13 that is pulled by a tongue 20 secured to the frame by an agricultural vehicle (not shown), such as a tractor. A pushing device 22 such as a hydraulic ram rotates a bed frame 14 about a pivot 28 with respect to trailer frame 12 between a first position for receiving bales 15 (not shown) in which the bed frame is positioned in a substantially horizontal orientation, and a second position for unloading the bales. Bales 15 that may be loaded onto the bale wagon can range in size from those reasonably capable of manual manipulation/removal from the bale wagon, to those weighing hundreds of pounds, and typically referred to as “large bales”. Bales 15 may be loaded on the wagon to form a stacked tier or tiers of bales. FIGS. 1-3 and 5 show the bale wagon 10 in the second position. As further shown in FIG. 2, and in the second position for unloading the bales, bed frame 14 extends substantially vertically and includes a backstop 40 extending substantially horizontally to support the weight of the bales 15 as the bales are being unloaded from the wagon. In one embodiment, backstop 40 includes a plurality of tines and may further include a skid plate 45 positioned near pivot 28 between bed frame 14 and trailer frame 12 to maintain a spacing 80 between the backstop and the ground to permit the bales 15 to be installed in a storage bag (FIG. 10) when pushed off of the bale wagon, if desired.

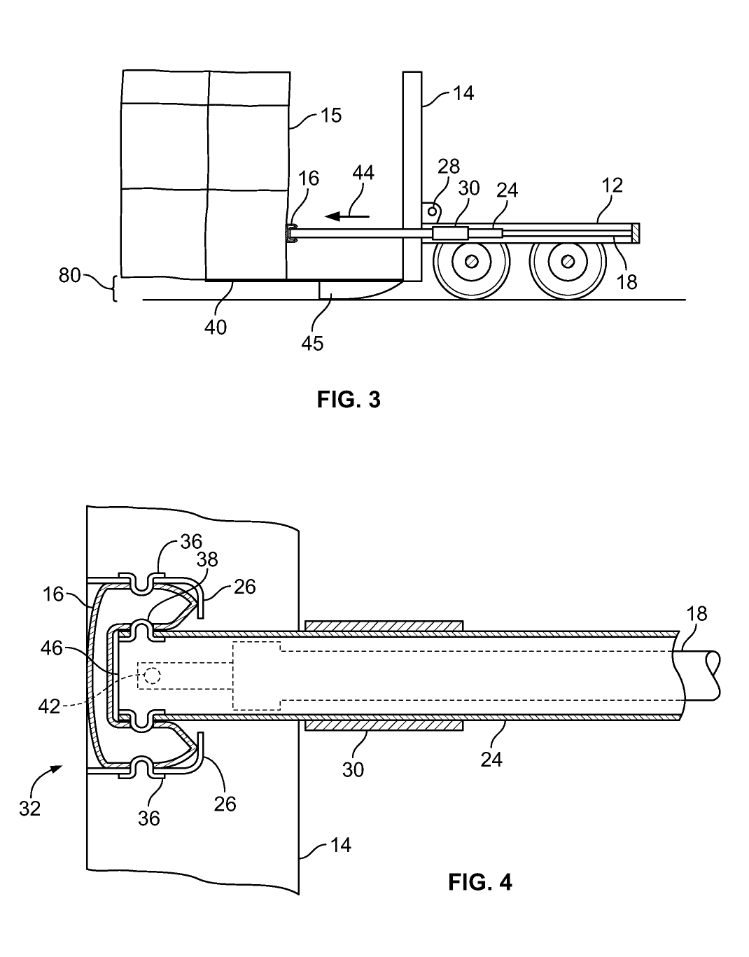

FIGS. 1-4 show a push-off member 16 for pushing bales 15 off of the bed frame 14 when the bed frame is in the second position. In one embodiment, push-off member 16 resembles a hollow C-shaped structure, although other profiles may be utilized. As further shown in FIG. 1, push-off member 16 substantially spans a width of trailer frame 12, applying a push-off force provided by a pushing device 18 (FIG. 3) to a first tier of bales 15. In one embodiment, for bed frame 14 positions other than the second position, push-off member 16 is in a seated position and is disconnected from pushing device 18 to provide clearance for pivoting movement between bed frame 14 and trailer frame 12. Pushing device 18, such as a hydraulic ram or a rotating threaded rod or similar device, provides a force applied in direction 44 (FIG. 3) urging push-off member 16 to remove bales from the bale wagon. Conversely, actuating pushing device 18 in a direction opposite direction 44, such as after the bales have been pushed off the wagon, urges push-off member 16 toward trailer frame 12 (toward a refracted position of the pushing device).

As further shown in FIG. 4, push-off member 16 rests or is “seated” in a seating member 26, which as shown, resembles a pair of L-brackets secured to facing inside surfaces of opposed structural members of bed frame 14, although other constructions may be used. In one embodiment, push-off member 16 is maintained in a substantially flush or recessed position with respect to the bed frame 14 surface on which bales 15 are placed, when the bed frame is in the first (bale loading) position. Push-off member 16 may be secured in its seated position and in close proximity to seating member 26 by a retention feature 36, such as a detent. The detent includes a flexible segment of material that is secured to an outside surface of seating member 26 and protrudes through an opening formed in seating member 26. Upon alignment of the opening formed in seating member 26 with a corresponding opening formed in push-off member 16, retention feature 36 protrudes through both aligned openings to secure push-off member 16 in the seated position. It is to be understood that a detent may be positioned differently than as described herein and that other embodiments of retention features, may be utilized, such as a spring-loaded retractable ball or the like.

As further shown in FIG. 4, opposed retention features 36 may be utilized to secure push-off member 16 in its seated position. FIG. 4 further shows end 46 of tube 24 in abutting contact with push-off member 16 in which push-off member 16 is maintained in close proximity to end 46 by a retention feature 38, such as a detent that may be secured to either push-off member 16 or to tube 24. In one embodiment, pushing device 18 is secured to tube 24 by pin connection 42. That is, as shown in FIG. 4, the detent 38 includes a flexible segment of material that may be secured to an inside surface of tube 24 and protrudes through an opening formed in tube 24. Upon alignment of the opening formed in tube 24 with a corresponding opening formed in push-off member 16, retention feature 38 protrudes through both aligned openings to secure push-off member 16 to tube 24. It is to be understood that a detent may be positioned differently than as described herein and that other embodiments of retention features, may be utilized such as a spring-loaded retractable ball or the like.

In one embodiment, the force required to dislodge detent 38, resulting in the disconnection between tube 24 and push-off member 16, is less than the force required to dislodge detent 36, resulting in the disconnection between seating member 26 and push-off member 16. Under normal operating conditions, push-off member 16 is always secured to either seating member 26 or to tube 24 at any given time (and may be secured to both seating member 26 and to tube 24 simultaneously when bed frame 14 is in the second position). That is, when bed frame 14 is in the first position or between the first position and the second position, push-off member 16 is in its seated position, i.e., in close proximity with seat member 26 and also disconnected from tube 24. In other words, tube 24 is in a retracted position to permit pivoting movement between trailer frame 12 and bed frame 14.

However, once bed frame 14 is in the second position, tube 24 may also be brought into abutting contact or in connection with push-off member 16 by actuation of pushing device 18. In one instance, as shown by FIG. 4, both detents 36, 38 are secured to push-off member 16. That is, push-off member 16 is still in its seated position, but is also in abutting contact with tube 24. Upon additional force applied along direction 44 (FIG. 3), push-off member 16 is dislodged from its seated position with seat member 26 to unload bales from the wagon. That is, push-off member 16 is brought into abutting contact with and urges bales 15 to begin to slide over backstop 40 away from seat member 26.

Pushing device 18, which is secured to trailer frame 12 at one end, is secured to tube 24 at the other end, such as by pin connection 42 (FIG. 4), the tube moving with respect to the trailer frame 12 during operation of the pushing device. In one embodiment, when pushing device 18 is in a refracted position, such as shown in FIG. 2, tube 24 substantially surrounds and covers the pushing device. Tube 24 helps protect pushing device 18, and helps prevent buckling of the pushing device, especially when used with a guide 30 that is secured to trailer frame 12. Tube 24 may additionally help prevent buckling of pushing device 18, if the cross-sectional area of the tube is only slightly larger than the cross-sectional area of the pushing device. In one embodiment, guide 30 is a tube within which the tube 24 of pushing device 18 slides.

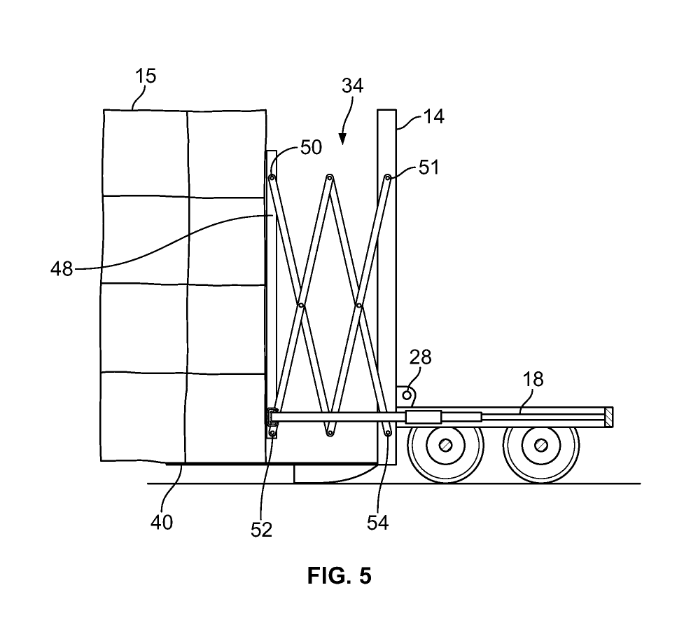

FIG. 5 shows an exemplary embodiment of the pushing device to include a vertical push-off assembly 34, such as a scissor linkage. Vertical push-off assembly 34 permits multiple tiers of bales 15 to be pushed simultaneously, with the primary load borne by pushing device 18. That is, vertical member 48 simultaneously abuts multiple tiers of bales 15, providing a more secure and stable platform from which to move the bales. In one embodiment the vertical push-off assembly 34 includes pin linkages 52, 54 with respective vertical member 48 and bed frame 14, respectively, and rollers 50, 51 configured to ride in bed frame 14 and vertical member 48, respectively. Due to the multiple tiers of bales 15 being pushed primarily by pushing device 18, the structural cross sectional size of the members comprising the vertical push-off assembly 34 may be significantly reduced. For example, at least portions of the linkages of vertical push-off assembly 34 may be composed of substantially flattened metal material, sometimes referred to as a leaf spring, which significantly reduces the weight of the assembly. In one embodiment, the only structural member connected to opposed members 48 of push-off assembly 34 is push-off member 16.

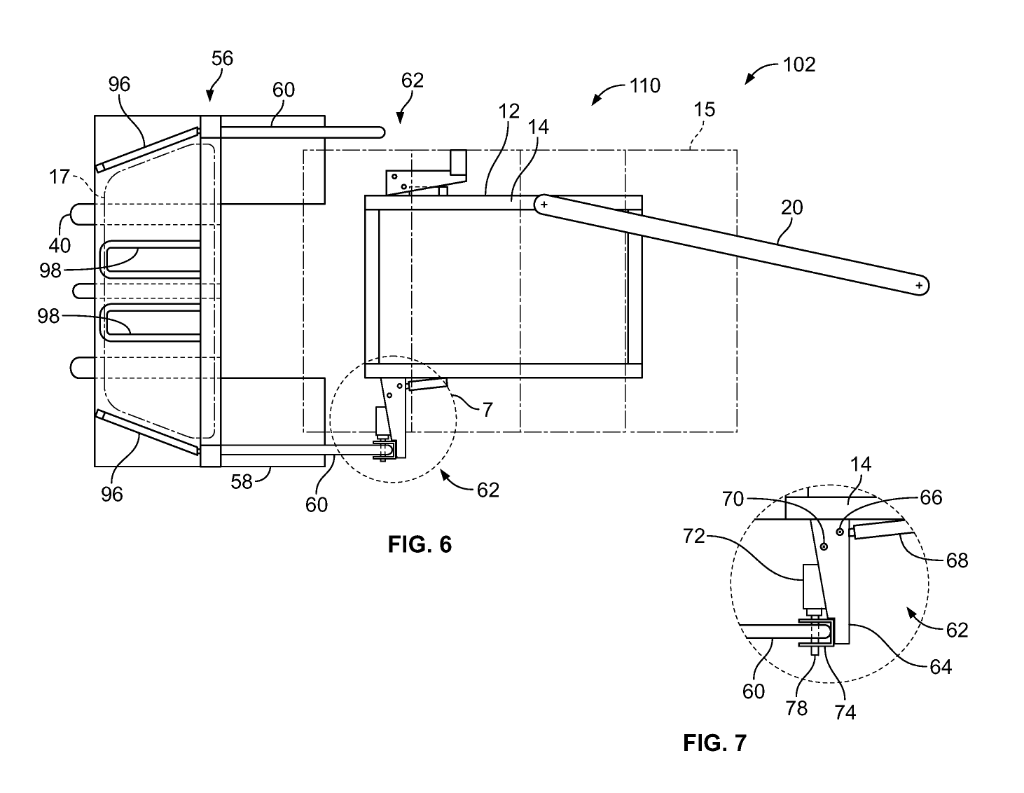

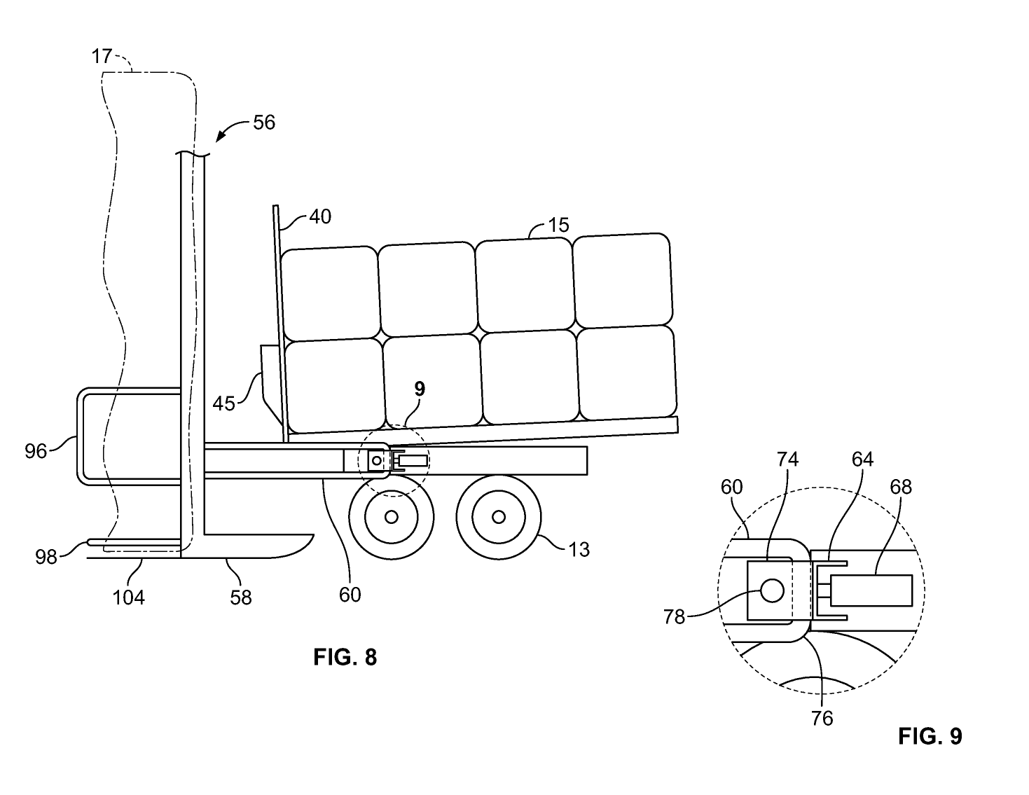

FIGS. 6-9 show an alternate embodiment of the system 102 for loading a bale in a continuous sheath or bale storage bag or bag 17. Bag 17 is secured to a bag dispensing structure 56 that includes, as shown, a base 58 and a pair of forward extending arms 60 utilized to secure the structure to bale wagon 110. In one embodiment, arms 60 include opposed U-shaped members that each extend substantially horizontally toward the bale wagon, in which the base of the U-shaped member defines a second engagement feature 76 for engaging a first engagement feature 74 of a member 62 extending from the bale wagon. As shown facing in a direction opposite of base 58, are securing members 96, 98. Securing member 96, also referred to as a pivoting hay dog, is configured to pivot about a substantially vertical axis to permit a bale 15 directed or inserted through bag dispensing structure 56 to be directed past securing member 96. Upon a bale being directed past securing member 96, the securing members each rotate about the pivotable connection between the securing member and the bag dispensing structure, preventing the bale from reentering the bag dispensing structure from the opposite direction, and maintaining the bag dispensing structure in position in preparation of receiving the next bale. Securing member 98 extends substantially horizontally above the ground, and similar to the tines of backstop 40 as shown in FIG. 3, is positioned to protect the bag 17 to be dispensed by bag dispensing structure 56 between securing member 98 and the ground 104 (and more precisely, between the dispensing members and the ground) in order to protect the bag as the bale is inserted inside of the bag. In an exemplary embodiment, dispensing members (not shown) are positioned in direct contact with the bag. That is, the bag is pulled off of the dispensing members of the bag dispensing structure, and not the securing members. Once the bale has been directed past securing members 96, 98 (FIG. 10), such as by push-off member 16 (FIG. 3), the bale is referred to as a previously directed bale 19, rests upon the ground and is positioned inside of bag 17, and secures the dispensing frame relative to the previously directed bale in a position to receive the next directed bale.

Once a first bale has been inserted inside the bag, i.e., the previously directed bale 19, subsequent or currently directed bales 15 are then directed through bag dispensing structure 56 until the currently directed bale 15 abuts or contacts the previously directed bale 19. Upon such contact, sufficient axial force as applied by push-off member 16 to the currently directed bale 15 results in a directed movement 100 of both bed frame 14 of the bale wagon and bag dispensing structure 56 with respect to bale 15, since the bed frame and the bag dispensing structure are secured together by virtue of a locking feature 78. Upon sufficient directed movement 100 of the bed frame and the bag dispensing structure such that bale 15 is directed past securing members 96, 98, the directed bale 15 then also becomes a previously directed bale 19 and the process continues until the bag 17 is filled with bales.

Referring back to FIGS. 6-9, member 62 is movably connected to trailer frame 12, and as further shown in FIG. 7, forms a pivotable connection 66 with respect to bale wagon 110 about a substantially vertical axis. In an alternate embodiment, member 62 may be movable in an axial or curved direction or a pivotable connection having a differently oriented axis, instead of pivotable connection 66. In one embodiment, while positioned in its retracted position, member 62 may be substantially surrounded by a protective structure, such as a C-channel, (not shown) extending from the bed frame. In other words, when retracted, member 62 would be substantially protected from vertical impact loads (e.g., bales falling from the bed frame). In one embodiment, member 62 may rotate more than 90° about an axis, such as a vertical axis, between the retracted and extended positions. A pushing device, such as a hydraulic ram 68 forms a pivotable connection 70 with member 62. Member 62 includes a structural body 64, such as a C-channel. Opposite pivotable connection 66 of member 62 is first engagement feature 74 for engaging second engagement feature 76 of arm 60 of bag dispensing structure 56. In one embodiment, first engagement feature 74 defines a docking channel, such as a C-channel. To maintain or secure engagement between first and second engagement features 74, 76, locking feature 78, such as an end of an actuating rod of a hydraulic ram 72, may be selectively inserted into openings formed in the first engagement feature. It is to be understood that other arrangements may also be employed to secure the bale wagon to bale dispensing structure.

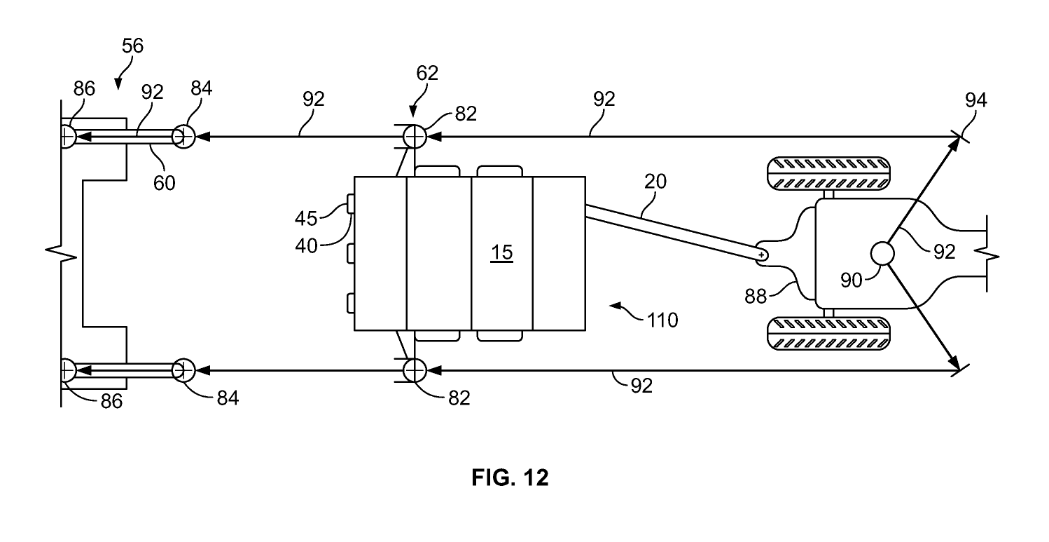

As further shown in FIGS. 6-9 and 12, the system of the present disclosure includes alignment features to assist an operator of an agricultural vehicle, such as a tractor, to direct the bale wagon toward the bag dispensing structure. As further shown in FIG. 12, an operator 90 seated in a tractor 88 that is connected to bale wagon 110, can make use of opposed lines of sight 92 using a mirror 94 and first, second and third alignment features 82, 84, 86. For example, member 62 when pivoted to an open position from its closed or retracted position, includes first alignment feature 82. Similarly, arms 60 of bag dispensing structure 56 includes a second alignment feature 84, with the bag dispensing structure further including a third alignment feature 86. Stated another way, in response to operator 90 utilizing the opposed lines of sight in combination with opposed mirrors 94, the operator is able to align the first, second and third alignment features 82, 84, 86 to achieve engagement between the bale wagon and the bag dispensing structure, i.e., the first and second engagement features 74, 76, respectively. Once engagement between the first and second engagement features has been achieved, actuation of locking device 78 (FIG. 7) may be utilized to secure the first and second engagement features together, prior to directing bales 15 into the bag dispensing structure 56. In one embodiment, the first, second and third alignment features 82, 84, 86 may be in the form of vertical lines. In a further embodiment, the first, second and third alignment features 82, 84, 86, such as vertical lines, may be associated with transparent mar-resistant components, such as plastic, tempered glass or other suitable material, permitting the alignment features to be viewable through the components to accommodate a wide range of operator vantage points as measured from the seat of the tractor, i.e., different operator heights. Alternately, one or more of the alignment features may be movable to achieve the two opposed lines of sight that are satisfactory for the operator to achieve alignment. It is to be understood that when the member is at or in close proximity to its fully retracted position, the operator has substantially unobscured lines of sight. In one embodiment, the member, when positioned in its retracted position, is not visible by the operator seated in the tractor and using the mirrors.

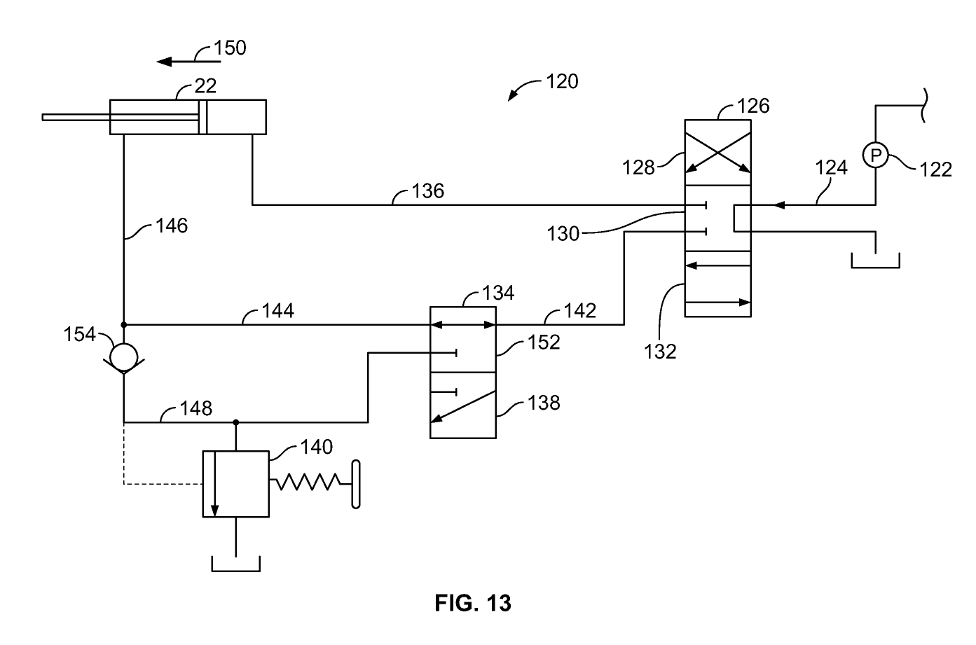

Referring to FIGS. 2, 8 and 13, a fluid circuit portion 120 of the present disclosure permitting weight transfer between bed frame 14 and wheels 13 of the bale wagon is now discussed. Fluid circuit portion 120 includes a pump 122 circulated through line 124 that is connected with a control valve 126 that controls the position or orientation of bed frame 14. Control valve 126 includes three positions; a tilt down position 128, a neutral position 130 and a tilt up position 132. Control valve 126 is connected to the hydraulic ram or pushing device 22 that controls angular orientation of the bed frame via line 136. A control valve 134 is also connected to control valve 126 via line 142. Control valve 134 includes a normal position 152 and an adjustment mode position 138. Control valve 134 is also connected to pushing device 22 via interconnected lines 144, 146. Opposite the junction between the lines 144, 146, a check valve 154 is connected via line 148 to control valve 134. Interposed between check valve 154 and control valve 134 is an adjustable relief valve 140.

In normal operation, i.e., control valve 134 being in normal position 152, upon the provision of sufficient pressurized fluid by pump 122 with control valve 126 being in tilt down position 128, pressurized fluid is directed through lines 142 control valve 134 and lines 144, 146 to direct pushing device 22 toward a first position or substantially horizontal orientation to permit bales to be loaded onto the bed frame of the bale wagon. Conversely, with control valve 134 being a normal position 152, upon the provision of sufficient pressurized fluid by pump 122 with control valve 126 in tilt up position 132, pressurized fluid is directed through line 136 to the piston of direct pushing device 22, urging the piston of the pushing device in a direction 150 toward the second position or substantially vertical orientation to permit loading of bales from the bed frame of the bale wagon.

Once pushing device 22 has moved the bed frame of the bale wagon to the second position, or bale unloading position, control valve 134 is shifted or actuated from the normal position 152 to the adjustment mode position 138 and control valve 126 is shifted to tilt down position 128. The adjustment mode position 138 in combination with and within the settings of adjustable relief valve 140, in effect, increases the fluid pressure in line 148. As a result of the increased fluid pressure in line 148 in accordance with the settings of the adjustable relief valve 140, check valve 154 will become unseated, resulting in a more equalized pressure fluid level in lines 142, 144, 146 with respect to the pressure level in line 148. The pressure level of lines 142, 144, 146 is set by the adjustable relief valve 140, providing a force in the opposite direction of 150, resulting in a change in weight distribution. As a result of the weight distribution shift, instead of the weight of the bales and the bed frame being predominantly supported by the skid plate or portion 45 (FIG. 2) of the bed frame, the weight is substantially borne by the wheels 13 of the bale wagon, improving the efficiency of the bale unloading process, due to a reduction in resistance to movement by wheels 13 as compared to movement of portion 45.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A system for loading a bale in a continuous storage bag comprising:
a structure configured and disposed to releasably dispense the bag in response to receiving a bale directed inside the structure, the directed bale being inserted inside the bag;
a bale wagon for receiving the bale;
a push-off member for directing the bale inside the structure from the bale wagon; and
a first member selectably movable between a first position and a second position with respect to the bale wagon to selectably secure the bale wagon to the structure.

2. The system of claim 1, wherein the first member is pivotably movable, and in the first position is substantially surrounded by a protective structure extending from the bale wagon.

3. The system of claim 1, wherein the first member includes a first alignment feature to align the bale wagon and the structure to facilitate directing the bale wagon toward the structure.

4. The system of claim 3, wherein the structure includes a second alignment feature to align the bale wagon toward the structure to facilitate directing the bale wagon toward the structure.

5. The system of claim 4, wherein the structure includes a third alignment feature to align the bale wagon toward the structure to facilitate directing the bale wagon toward the structure.

6. The system of claim 5, wherein the alignment features include vertical markers.

7. The system of claim 1, wherein the bale wagon comprises a mobile trailer frame having a bed frame for receiving and unloading the bale, the bed frame is pivotably movable between a first position for receiving the bale and a second position for unloading the bale.

8. The system of claim 7, wherein the push-off member directs the bale inside the structure from the bale wagon when the bed frame is in the second position.

9. The system of claim 1, wherein the first member includes a first engagement feature to selectably engage the bale wagon and the structure.

10. The system of claim 9, wherein the structure includes a second engagement feature configured to engage the first engagement feature.

11. The system of claim 1, wherein a hydraulic ram selectively pivots the first member between a first position and a second position with respect to the bale wagon.

12. The system of claim 11, wherein the first member includes a locking feature to secure the first engagement feature to the second engagement feature.

13. The system of claim 7, wherein the bed frame includes a backstop having a portion that contacts the ground when the bed frame is in the second position, the portion maintaining a spacing between the backstop and the ground to permit dispensing of the bag during bale unloading.

14. The system of claim 13, comprising a fluid system to selectably transfer weight of the bales and bed frame to wheels of the mobile trailer frame.

15. A system for loading a bale in a continuous storage bag comprising:
a structure configured and disposed to releasably dispense the bag in response to receiving a bale directed inside the structure, the directed bale being inserted inside the bag;
a bale wagon comprising a mobile trailer frame having a bed frame for receiving and unloading bales; the bed frame pivotably movable between a first position for receiving bales and a second position for unloading bales;
a push-off member for directing the bales inside the structure from the bale wagon; and when the bed frame is in the second position; and
a first member selectably pivotable between a first position and a second position with respect to the bale wagon to selectably secure the bale wagon to the structure.

16. A method for loading a bale in a continuous storage bag comprising the steps of:
providing a structure configured and disposed to releasably dispense the bag in response to receiving a bale directed inside the structure, the directed bale being inserted inside the bag;
providing a bale wagon configured to receive and to unload the bale;
moving a first member with respect to the bale wagon from a first position to a second position;
guiding the bale wagon toward an engagement position with the structure using the first member as an alignment guide;
securing the first member to the structure; and
directing the bale inside the structure.

17. The method of claim 16, wherein the step of directing the bale continues until the bale, the bale being the first bale inserted inside the bag, is directed past a dispensing member of the structure.

18. The method of claim 16, wherein the step of directing the bale continues until the bale abuts a previously directed bale already positioned inside the bag, and further including an additional step subsequent to the step of directing the bale, of further directing the bale after abutting the previously directed bale until the structure and the bale wagon is directed to movement, resulting in a dispensing member of the structure moving past the bale being directed.

19. The method of claim 16, wherein the bale wagon comprises a mobile trailer frame having a bed frame for receiving and unloading the bale, the bed frame being pivotably movable between a first position for receiving the bale and a second position for unloading the bale, and further including an additional step of providing a push-off member to direct the bale inside the structure from the bale wagon when the bed frame is in the second position.

20. The method of claim 19, wherein the step of directing the bale includes selectably transferring at least a portion of the weight of the bale and bed frame to wheels of the mobile trailer frame.
